(19) United States
(12) Patent Application Publication
(10) Pub. No.: US 2026/0239183 A1
(43) Pub. Date: Aug. 13, 2026

(54) SESSION MANAGEMENT FUNCTION SELECTION

(71) Applicant: T-MOBILE INNOVATIONS LLC, Overland Park, KS (US)

(72) Inventor: Kunal BARAWKAR, Bothell, WA (US)

(21) Appl. No.: 19/051,639

(22) Filed: Feb. 12, 2025

(51) Int. Cl. H04W 48/18; H04W 76/10

(52) U.S. Cl. CPC H04W 48/18; H04W 76/10

(57) ABSTRACT

Methods and systems provided herein include a session management function (SMF) selection mechanism to ensure continuity of sessions during inter-radio access technology mobility. Upon failure to locate an SMF for managing a session based on the fully qualified domain name (FQDN), the session management selection system may match a packet data network gateway (PGW) S5 internet protocol (IP) address with an N11 IP address contained in an SMF profile.

### TECHNICAL BACKGROUND

As wireless networks evolve and grow, there are ongoing challenges in communicating data across different types of networks. For example, a wireless network may include one or more access nodes, such as base stations, including, for example, evolved NodeBs (eNodeBs or eNBs) and next generation NodeBs (gNodeBs or gNBs) for providing wireless voice and data service to wireless devices in various coverage areas of the one or more access nodes. As wireless technology continues to improve, various different iterations of radio access technologies (RATs) may be deployed within a single wireless network. Such heterogeneous wireless networks can include newer 5G and millimeter wave (mm-wave) networks, 6G networks, as well as 4G long-term evolution (LTE) access nodes.

5G networks include a core network utilizing a service based architecture (SBA) with multiple network functions (NFs). During the evolution of newer wireless RATs, improved voice services have become available. For example, with 4G networks, Voice over Long-Term Evolution (VoLTE), which is an LTE high speed wireless communication standard for voice calls became available. Further, with the development of 5G networks, Voice over New Radio (VoNR), which fully utilizes the 5G standalone (SA) core network was developed. Other 5G services have also become available that were not available with previous network architectures. Accordingly, wireless devices or user equipment (UEs) may be capable of using multiple network architectures and may transition between networks as appropriate.

As an example, to transition between 4G LTE networks and 5G NR SA networks, wireless devices requesting establishment of a session will contact an access and mobility function (AMF) of a 5G network, which communicates with an management and mobility entity (MME) of the 4G LTE network. In order for the AMF to select a session management function (SMF) for managing a session with the wireless device, the AMF collects information from the MME over an N26 interface. Using this information, the AMF attempts to find an SMF of the 5G core network that is equivalent to the PGW of the 4G network in order to facilitate session continuity. However, node configuration errors can result in a failure to locate the SMF and an interruption in service. Accordingly, solutions are needed for improving SMF selection during 4G to 5G mobility.

### OVERVIEW

Exemplary embodiments provided herein include a method and system for selecting a session management function (SMF) during inter-RAT mobility. A method includes querying a network repository function (NRF) from an access and mobility function (AMF) with a fully qualified domain name (FQDN) to locate a session management function (SMF) for managing a session during long term evolution (LTE) to fifth generation (5G) standalone (SA) mobility. Upon failing to locate the SMF based on the FQDN, the method includes locating the SMF by matching a packet data network gateway (PGW) internet protocol (IP) address with an N11 IP address from an SMF profile.

Further exemplary embodiments include a system for SMF selection. The system may include a memory storing data and instructions and a processor executing the instructions to perform multiple operations. The multiple operations include receiving a notification of failure to locate a matching SMF for managing a session during long term evolution (LTE) to fifth generation (5G) standalone (SA) mobility for a wireless device. The operations additionally include responsive to the notification, upon failure to locate the SMF for managing the session, checking a local cache to locate a profile for the SMF for managing the session by matching a packet data network gateway (PGW) internet protocol (IP) address with an N11 IP address of an SMF profile.

In yet further embodiments, a non-transitory computer readable medium is provided that stores instructions executed by a processor to perform multiple operations. The operations include receiving a notification of failure to locate a matching session management function (SMF) for managing a session during long term evolution (LTE) to fifth generation (5G) standalone (SA) mobility for a wireless device. Responsive to the notification and upon failure to locate the SMF for managing the session, the operations include locating a profile for the SMF for managing the session by matching a packet data network gateway (PGW) internet protocol (IP) address with an N11 IP address of an SMF profile.

Embodiments disclosed herein further include a processing node or AMF performing the operations described herein.

### BRIEF DESCRIPTION OF THE DRAWINGS

FIG. 1 depicts an exemplary environment for session management function (SMF) selection in accordance with an embodiment.

FIG. 2 depicts further details of an operating environment for SMF selection in accordance with an embodiment.

FIG. 3 depicts an exemplary SMF selection system in accordance with an embodiment.

FIG. 4 depicts an exemplary method for smf selection in accordance with an embodiment.

FIG. 5 depicts a further exemplary method for SMF selection in accordance with an embodiment.

FIG. 6 depicts an additional exemplary method for SMF selection in accordance with an embodiment.

FIG. 7 illustrates alternative SMF selection methods in accordance with embodiments.

FIG. 8 depicts SMF selection methods based on a wireless device request in accordance with an embodiment.

### DETAILED DESCRIPTION

During LTE to 5G mobility, upon receiving a connection request from the wireless device, the mobility management entity (MME) of the LTE core network interacts with the access and mobility function (AMF) of the 5G core network and transfers device sessions to the AMF. A session is a logical connection between the wireless device and a data network that enables the transmission of user data between the wireless device and the 5G core network. Based on the information received from the MME, the AMF selects a session management function (SMF) for managing the continued session and forwards the session information to the SMF. In order to select an SMF from multiple SMFs in the network, the AMF interacts with a network repository function (NRF) of the 5G core network. As explained above, difficulties can arise in selecting the appropriate SMF for managing continuing sessions due to misconfigurations, human error, or other factors.

Accordingly, in embodiments provided herein, an SMF selection mechanism is provided that includes multiple fallback techniques for selecting the SMF for session continuity. When the AMF queries the MME, the MME sends multiple information items. One information item is the fully qualified domain name (FQDN) of the packet data network gateway (PGW) of the 4G LTE network. The FQDN is a complete address for a computer or Internet host and provides the exact location within a domain name system (DNS). Another information item transmitted from the MME to the AMF is a PGW S5 Internet protocol IP address. In embodiments provided herein, the SMF selection mechanism utilizes both of these information items to select an SMF from multiple SMFs for session continuity.

Embodiments provided herein include a fallback mechanism when an FQDN mismatch occurs. For example, the AMF may query the network repository function (NRF) for an SMF having an FQDN matching the FQDN provided by the MME. The NRF is a central registry, holding information about network functions (NFs) that can be shared with other NFs. In some instances, due to misconfiguration, the NRF may fail to return a matching result for the FQDN query as it is unable to locate an SMF having a matching FQDN to the PGW. Accordingly, in embodiments described herein, if the NRF query fails, the SMF selection mechanism triggers the AMF to match the PGW S5IP address with an N11 IP address of an SMF.

In some embodiments, the SMF selection mechanism matches the PGW S5 IP address with an N11 IP address by searching locally cached SMF profiles for the N11 IP address. For example, because the AMF regularly interacts with the NRF, it may store recently used SMF profiles in a local cache. In some instances, the AMF does a tracking area code (TAC) and slice query and obtains a list of SMFs retained in the local cache. Upon receiving a request, the AMF may build a local database including SMF profiles of locally stored SMFs in the region. Further, in addition to, or as an alternative to storing the local cache of SMF profiles at the AMF, the local cache of SMF profiles may be stored in an SMF selection system in a separate processing node connected with, or in communication with, the AMF.

As an alternative, or as a further fallback mechanism if the local cache of SMF profiles does not include an SMF profile having an N11 IP address matching the PGW S5 IP address, then the SMF selection system can trigger the AMF to pull all SMF profiles from the NRF, for example, using an NFType=SMF query towards NRF. As a result, the AMF may pull all SMF profiles and utilize a matching function of the SMF selection system to find an SMF having an N11 IP address matching the PGW S5 IP address.

Accordingly, in embodiments provided herein, if a match can be found on either the FQDN or the PGW S5 IP address and N11 IP address, then session continuity is achieved. The AMF will only drop the packet data network (PDN) if no match on either the FQDN or IP addresses can be found.

Architecturally, solutions provided herein leverage a combi-gateway that includes an SMF and PGW. The combi-gateway utilizes the same IP address for S5 and N11 interfaces. Accordingly, when a wireless device sends a session establishment request to the AMF, the AMF interacts with the MME to select an SMF having an N11 IP address matching the S5 IP address of the PGW. Accordingly, embodiments described herein facilitate SMF selection during 4G LTE to 5G mobility. The efficient selection of the SMF ensures continuity and improves network performance.

In addition to the systems and methods described herein, non-transitory computer-readable mediums, processing nodes, and/or AMFs may store the operations for the instructions or methods. Processing nodes on the network may include a processor included in a network function, such as for example, the AMF, or a processor included in any controller node in the wireless network.

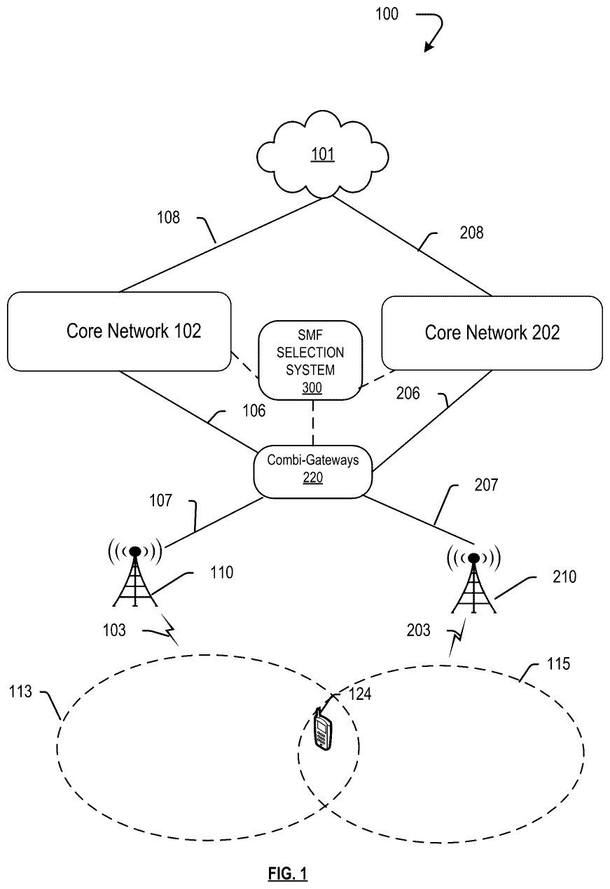

FIG. 1 depicts an exemplary environment 100 for implementing an SMF selection system 300. Environment 100 comprises a communication network 101, core networks 102 and 202, and one or more radio access networks (RANs) including at least access nodes 110 and 210. Wireless device 124 is located in coverage areas 113 and 115 and may communicate with the access node 110 over communication link 103 and/or access node 210 over a communication link 203. In embodiments set forth herein, the access node 110 may be an eNB and the core network 102 may be a 4G LTE core network. The access node 210 may be a gNB and the core network 202 may be or include a 5G standalone (SA) network having a service based architecture (SBA). Although only one wireless device 124 is shown, it should be understood that any number of wireless devices could be included.

Further, the SMF selection system 300 interacts with the core networks 102, 202 and combi-gateways 220, which may be wholly or partially incorporated in the core networks 102 and 202. The combi-gateways 220 combine features of the 4G and 5G architectures in order to facilitate mobility between core networks 102, 202.

Specifically, the SMF selection system 300 operates between the core networks 102 and 202, for example, between an MME in the core network 102 and an AMF in the core network 202 to retrieve session information from the core network 102 and identify an SMF in the combi-gateway 220 for managing a session previously managed through a PGW in the combi-gateway 220. The SMF selection system 300 further operates to facilitate session continuity for the wireless device 124.

The core network 102 may include an EPC architecture while the core network 202 may include an SBA architecture. In the SBA architecture, service-based interfaces may be utilized between control plane functions, while multiple user plane functions connect over point-to-point link.

The RAN can include various access network functions and devices disposed between the core networks 102, 202 and the end-user wireless device 124. For example, the RAN includes at least an access node (or base station), such as an eNodeB and/or a next generation NodeB (gNodeB) 110, 210 communicating with the end-user wireless device 124. Further, either of core network 102 and RAN can include one or more of a local area network, a wide area network, and an internetwork (including the Internet) and be capable of communicating signals and carrying data, for example, to support voice, push-to-talk, broadcast video, and data communications by end-user wireless device 124.

Access nodes 110, 210 can be any network node configured to provide communication between end-user wireless device 124 and communication network 101, including standard access nodes and/or short range, low power, small access nodes. For instance, access nodes 110, 210 may include any standard access node, such as a macrocell access node, base transceiver station, or a radio base station, or the like. In embodiments further discussed herein, the access node 110 is an eNB and the access node 210 is a next generation NodeB (gNB). However, the access nodes 110, 210 may include multiple co-located access nodes, such as a combination of eNodeBs and gNodeBs. Access nodes 110, 210 can be a small access node including a microcell access node, a picocell access node, a femtocell access node, or the like such as a home NodeB or a home eNodeB device. Moreover, it is noted that while access nodes 110 and 210 and wireless device 124 are illustrated in FIG. 1, any number of access nodes and wireless devices can be implemented within environment 100.

By utilizing antennas, access nodes 110, 210 can deploy a wireless air interface 103, 203 using one or more frequency bands over one or more coverage areas 113, 115. Further, the different sets of antennas can be used to implement various transmission modes or operating modes in each sector, including but not limited to multiple in multiple out (MIMO), carrier aggregation (including inter-band and intra-band carrier aggregation), and different duplexing modes including frequency division duplexing (FDD) and time division duplexing (TDD).

Wireless device 124 may be any device, system, combination of devices, or other such communication platform capable of communicating wirelessly with access node 110 or 210 using one or more frequency bands deployed therefrom. Wireless device 124 may be, for example, a mobile phone, a wireless phone, a wireless modem, a personal digital assistant (PDA), a voice over internet protocol (VoIP) phone, a voice over packet (VOP) phone, a soft phone, a home internet (HINT) device, a fixed wireless access (FWA) device as well as other types of devices or systems that can exchange audio or data via access node 110. The FWA devices may include, for example, customer premises equipment (CPE). Additionally, wireless devices have evolved to include Internet of things (IoT) devices, which describes the network of physical objects or things that are embedded with sensors, software, and other technologies for the purpose of connecting and exchanging data with other devices and systems over the Internet. The wireless device 124 can be end-user wireless devices (e.g., user equipment (UEs)) utilizing communication links 103, 203, which may operate based on 6G, 5G new radio (NR), 4G long term evolution (LTE), or any other suitable type of ratio access technology (RAT).

Communication network 101 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 101 can be capable of carrying data, for example, to support voice, push-to-talk, broadcast video, and data communications by wireless device 124. Wireless network protocols can comprise multimedia broadcast multicast services (MBMS), code division multiple access (CDMA) single-Carrier radio transmission technology(1xRTT), Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 101 can also comprise additional base stations, controller nodes, telephony switches, internet routers, network gateways, computer systems, communication links, or some other type of communication equipment, and combinations thereof.

Communication links 106, 107, 108, and 206, 207, 208 can use various communication media, such as air, space, metal, optical fiber, or some other signal propagation path-including combinations thereof. Communication links 106, 107, 108, and 206, 207, 208 can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol as described herein. Communication links 106, 107, 108, and 206, 207, 208 can be a direct link or might include various equipment, intermediate components, systems, and networks. Communication links 106, 107, 108, and 206, 207, 208 may comprise many different signals sharing the same link.

Other network elements may be present in environment 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g. between access nodes 110, 210 and communication network 101.

Further, the methods, systems, devices, networks, NFs, access nodes, and equipment described above may be implemented with, contain, or be executed by one or more computer systems and/or processing nodes. The methods described above may also be stored on a non-transitory computer readable medium. Many of the elements of communication environment 100 may be, comprise, or include computers systems and/or processing nodes.

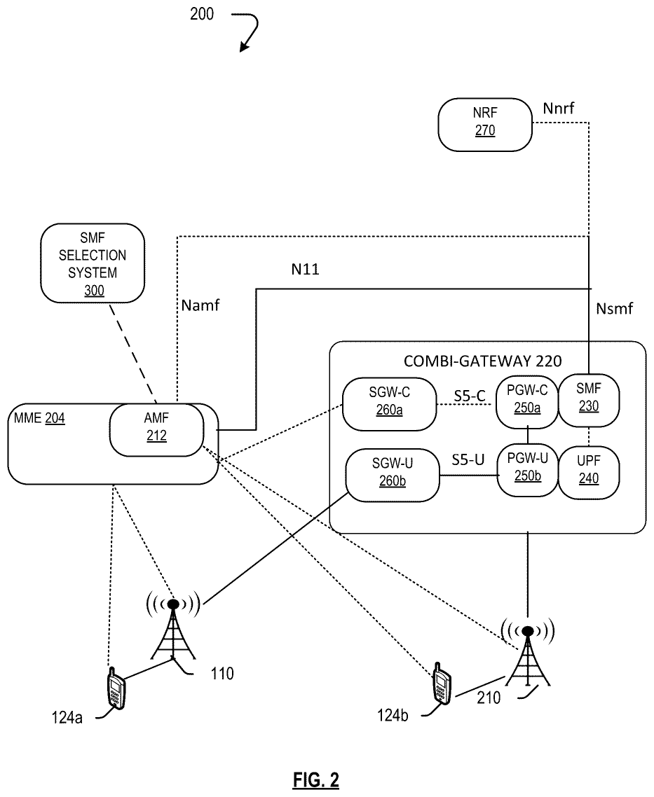

FIG. 2 depicts further details including an exemplary environment 200 for implementing an SMF selection system 300. More specifically, FIG. 2 illustrates 4G and 5G components and interfaces. In the illustrated embodiment, user plane interfaces are illustrated with solid lines, control plane interfaces are illustrated with dotted lines, and the communication with the SMF selection system 300 is illustrated as a dashed line.

The combi-gateway 220 includes 4G LTE components such as a control plane serving gateway (SGW-C) 260a, user plane SGW (SGW-U) 260b, a control plane packet gateway (PGW-C) 250a, and a user plane packet gateway (PGW-U) 250b. The interface between the SGW 260a, 260b and the PGW 250a, 250b that exist in the same public land mobile network (PLMN) is called the S5 Interface,

The combi-gateway 220 further include an SMF 230, and a UPF 240. Although a single SMF 230 and single UPF 240 are shown, it should be understood that multiple SMFs 230 and UPFs 240 may function within a combi-gateway 220 and that multiple combi-gateways 220 may function within the environment 200. It should be understood that the LTE PGW-C 250a functions within a 4G LTE network in a similar manner to that of the SMF 230 within a 5G network. Further, the LTE-PGW-U 250b functions similarly to the UPF 240 in a 5G network. An MME 204 functions as a mobility entity within a 4G LTE core network whereas an AMF 212 functions as the mobility entity within a 5G network. It should be noted that the 4G LTE SGW-C 260a and SGW-U 260b do not have a relevant 5G mapping.

Wireless devices 124a, 124b may communicate with access nodes 110, 210, which interact with the MME 204 and the AMF 212. In operation, a wireless device 124b may request to establish a 5G session through the AMF 212 while simultaneously connected to the LTE core network through the MME 204. This may occur, for example, when the wireless device 124b requires services available through the 5G network that are not available through the 4G LTE network. Thus, the AMF 212 searches for the SMF 230, which is one of multiple SMFs, to serve the wireless device 124b and then forwards the session request to the SMF 230 to continue the session in 5G over an N11 interface. The N11 interface serves as the reference point between the AMF 212 and the SMF 230.

Thus, the AMF 212 is responsible for managing the initial connection between the wireless device 124b and the 5G core network. When the wireless device 124b requests access to data or voice services, the AMF 212 triggers the SMF 230 via the N11 interface to create a new PDU session, modify an existing session, or terminate a session. The N11 interface within the 5G core network offers services to the AMF via a Namf service based N11 interface. The Nsmf interface is a service based interface for the SMF 230.

The interaction between the AMF 212 and the SMF 230 ensures that user sessions are efficiently managed. However, the AMF 212, in cooperation with the SMF selection system 300, initially must select an SMF 230 from multiple SMFs. The AMF 212 selects an SMF 230 based on the information provided by the MME 204. During LTE to 5G mobility, the MME 204 transfers a PDN connection list to AMF 212. Each PDN connection has PGW fully qualified domain name (FQDN). Further, each network interface has its own IP address. Thus, both the S5 interface between the 4G components and the N11 interface between the 5G components each has an IP address. In operation, the MME 204 transfers, in addition to the FQDN, an S5 IP address of the PGW-C 250a to the AMF 212. The AMF 212 utilizes the received FQDN and/or S5 IP address to find the equivalent SMF 230 to the PGW-C 250a.

In order to find the equivalent SMF to the PGW-C 250a, SMF selection system 300 attempts to find an SMF having an FQDN that matches the PGW FQDN. As an additional or alternative step, the SMF selection system 300 searches SMF profiles for an SMF having an N11 IP address that matches the S5 IP address. A network repository function (NRF) 270 or a local cache at the AMF 212 or the SMF selection system 300 may store the SMF profiles. Thus, in embodiments set forth herein, SMF selection is based on the N11 address contained in an SMF profile matching an S5 IP address provided to the AMF 212 by the MME 204. Accordingly, while the AMF 212 or the SMF selection system 300 may store SMF profiles in a local cache, the AMF 212 may additionally or alternatively query the NRF 270 to pull all SMF profiles contained in the NRF 270. Thus, the AMF 212 or SMF selection system 300 may identify the SMF 230 that can handle the connection request by querying the NRF 270. The NRF 270 stores SMF profiles and each SMF profile may include an N11 IP address.

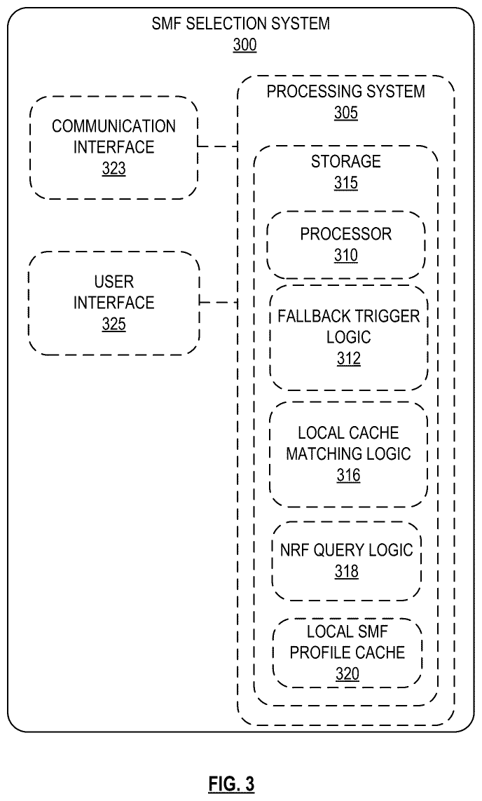

FIG. 3 illustrates a session management function (SMF) selection system 300 in accordance with embodiments described herein. The components described herein are merely exemplary as many different configurations for the SMF selection system 300 may be implemented. The SMF selection system 300 may be configured to perform the methods and operations disclosed herein to dynamically select an SMF during mobility operations in order to provide session continuity.

In the disclosed embodiments, the SMF selection system 300 may be integrated with the core network 202, for example with the AMF 212. Alternatively, the SMF selection system 300 may be an entirely separate component capable of communicating with the AMF 212 and/or NRF 270. Further, the components of the SMF selection system 300 may be distributed so that one or more components are located within a separate processing node, the AMF 212, and/or the NRF 270.

The SMF selection system 300 may be configured for performing the operations described herein utilizing a processing system 305. Processing system 305 may include a processor 310 and a storage device 315. Storage device 315 may include a random access memory (RAM), read-only memory (ROM), disk drive, a flash drive, a memory, or other storage device configured to store data and/or computer readable instructions or codes (e.g., software). The computer executable instructions or codes may be accessed and executed by processor 310 to perform various methods disclosed herein. Software stored in storage device 315 may include computer programs, firmware, or other form of machine-readable instructions, including an operating system, utilities, drivers, network interfaces, applications, or other type of software. For example, software stored in storage device 315 may include a module for performing various operations described herein. Further, the storage device 315 may include a local SMF profile cache 320. The local SMF profile cache 320 may include SMF profiles periodically downloaded from the NRF 270.

Fallback trigger logic 312 may be utilized upon detection of a failed SMF match to trigger a different type of SMF match. For example, if an FQDN match fails, then the fallback trigger logic 312 may trigger one of the local cache matching logic 316 and NRF query logic 318. The local cache matching logic 316 may search the local cache 320 for an SMF profile having an N11 IP address matching the S5 IP address of the PGW. Upon identifying a match, the local cache matching logic 316 may select the SMF corresponding to the SMF profile as the matching SMF to manage the 5G session. For example, the management of the 5G session by the SMF may include functions such as establishment of the session, modification of the session, release of the session, etc. Additionally or alternatively, NRF query logic 318 may be provided to trigger the AMF 212 to query the NRF 270 for all stored SMF profiles. The NRF logic 318 may further determine which SMF profile contains an N11 IP address corresponding to the S5 IP address of the PGW-C 250a. Upon finding an N11IP address matching with the S5 IP address, the NRF query logic 318 may select the SMF corresponding to the SMF profile have the matching N11 IP address as the SMF for managing the continuing session for the 5G network.

In embodiments provided herein, the local cache matching logic 316 may operate prior to the NRF query logic 318 as searching the local SMF profile cache 320 can be achieved more quickly than completion of the NRF query. Thus, the NRF query logic 318 may only be activated when the local cache matching logic 316 fails to locate the SMF for managing the continuing session. To perform the above-described operations, the fallback trigger logic 312, local cache matching logic 316, and NRF query logic 318 may be executed by the processor 310 to manage selection of an SMF for a continuing session.

Processor 310 may be a microprocessor and may include hardware circuitry and/or embedded codes configured to retrieve and execute software stored in storage device 315. The SMF selection system 300 further includes a communication interface 323 and a user interface 325. Communication interface 323 may be configured to enable the processing system 305 to communicate with other components, nodes, or devices in the wireless network.

Communication interface 323 may include hardware components, such as network communication ports, devices, routers, wires, antenna, transceivers, etc. User interface 325 may be configured to allow a user to provide input to the SMF selection system 300 and receive data or information from other system components. User interface 325 may include hardware components, such as touch screens, buttons, displays, speakers, etc. The SMF selection system 300 may further include other components such as a power management unit, a control interface unit, etc.

The location of the SMF selection system 300 may depend upon the network architecture. As set forth above, the SMF selection system 300 may be located in the AMF 212 or in a separate processing node. Further, although shown as a single integrated system, the components of the SMF selection system 300 may be separated and be disposed in separate locations.

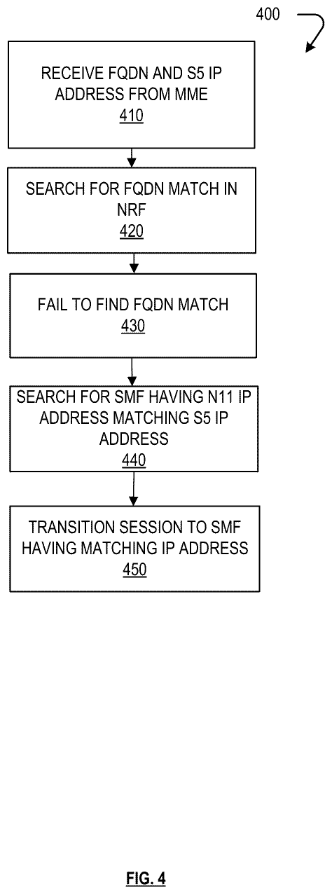

FIG. 4 illustrates a generalized exemplary method 400 for selecting an SMF during 4G LTE to 5G mobility in accordance with embodiments disclosed herein. Method 400 may be performed by a processor, for example, the processor 310 included in the SMF selection system 300. For discussion purposes, as an example, method 400 is described as being performed by the processor 310 of the SMF selection system 300. However, it should be understood that the steps illustrated in FIG. 3 are performed in conjunction with the AMF 212 and that processor 310 may, in fact, be incorporated in the AMF 212.

Method 400 starts in step 410, in which the processor 310 receives the FQDN and S5 IP address of the PGW-C 250a from the MME 204. The processor 310 receives this information when the AMF 212 interacts with the MME 204 to obtain session information. In step 420, the processor 310 utilizes the received FQDN from step 410 to search for an FQDN match in the NRF 270. In the illustrated embodiment, in step 430, the processor 310 fails to find a match on the FQDN. The failure to find the match may activate the fallback trigger logic 312 as described above with respect to FIG. 3.

Resultant to the failure in step 430, the processor 310 searches for an N11 IP address in an SMF profile matching the S5 IP address of the PGW-C 250a in step 440. Finally, in step 450, the processor 310 transitions the session to the SMF having the matching N11 IP address in its SMF profile to ensure session continuity during 4G LTE to 5G mobility. As further set forth herein, multiple methods exist for locating the N11IP address in the SMF profile that matches the S5 IP address of the PGW-C 250a and the local cache matching logic 316 and/or the NRF query logic 318 may be executed by the processor 310 in order to find the match.

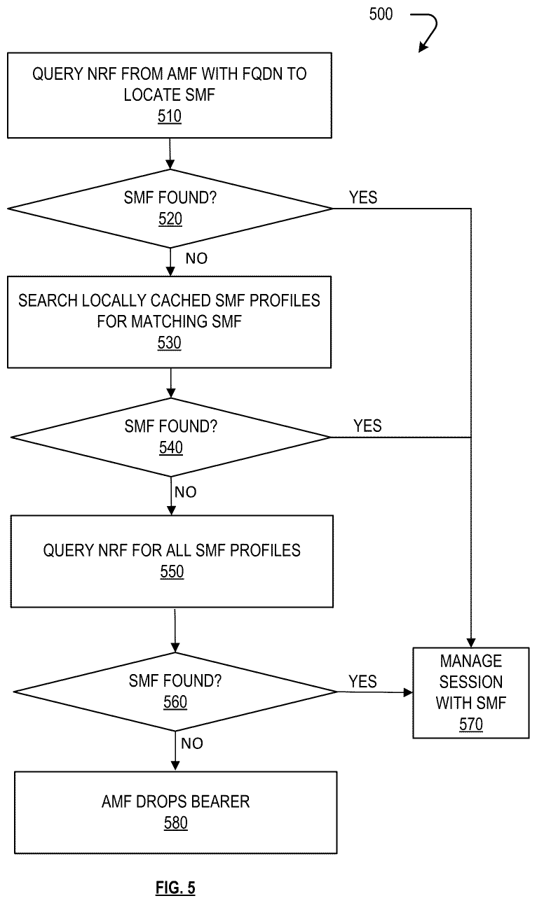

FIG. 5 depicts a further exemplary method 500 for selecting an SMF to manage a session. Method 500 may be performed by any suitable processor discussed herein, for example, the processor 310 included in the SMF selection system 300 or another processor of the core network 202, such as a processor of the AMF 212. For discussion purposes, as an example, method 500 is described as being performed by the processor 310 included in the SMF selection system 300, which may be partially or wholly incorporated in the AMF 212. However, the SMF selection system 300 may be separate from the AMF 212 in other example implementations.

Method 500 starts in step 510, in which the processor 310 queries the NRF 270 with an FQDN of the PGW-C 250a received from the MME 204 to find a matching FQDN for an SMF. In step 520, if a match is found, the processor 310 triggers management of the session with the matching SMF in step 570.

If no match is found in step 520, the processor 310 searches locally cached SMF profiles for a matching SMF. More specifically, the processor 310 searches the locally cached SMF profiles for an N11 IP address matching the S5 IP address received from the MME 204. The locally cached SMF profiles may be located at the SMF selection system 300 or at the AMF 212. In step 540, the processor 310 determines if a match is found. If a match is found, the processor 310 triggers management of the session with the matching SMF in step 570.

If no match is found in step 540, the processor 310 queries the NRF 270 for all SMF profiles in step 550. The query can include tracking area code (TAC) plus data network name (DNN), for example, Again, the processor searches for SMF profiles having an N11 IP address matching the S5 IP address received from the MME 204. In step 560, the processor 310 determines if a match is found. If a match is found, the processor 310 triggers management of the session with the matching SMF in step 570. However, if no match is found, the AMF 212 drops the bearer in step 580 and the connection will be lost.

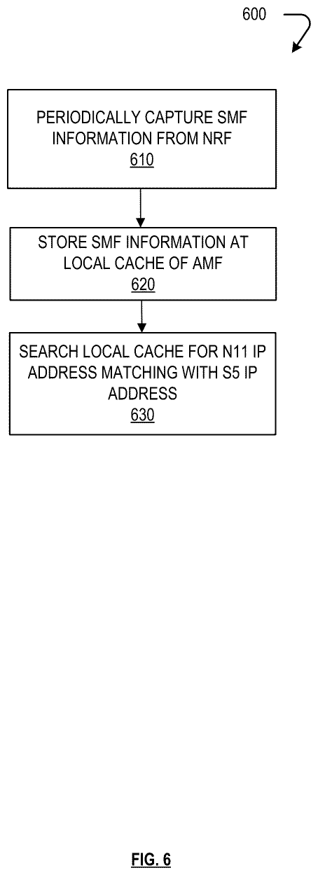

FIG. 6 depicts an additional exemplary method 600 for SMF selection in accordance with an embodiment. Method 600 may be performed by any suitable processor discussed herein, for example, the processor 310 in the SMF selection system 300, which may be partially or wholly incorporated in the AMF 212. For discussion purposes, as an example, method 600 is described as being performed by the processor 310 included in the SMF selection system and incorporated in the AMF 212.

In step 610, the processor 310 periodically captures SMF profiles from the NRF 170. This process occurs upon initiating the AMF 212 when the SMF queries the NRF 270. In step 620, the processor 310 stores the captured SMF profiles in a local cache in the SMF selection system 300 or in the AMF 212. Typically the AMF performs a tracking area code and slice query on the NRF 270 and obtains a short list of SMFs and stores it locally. Thus, upon activation, the AMF 212 builds local database of all SMFs in the region.

Finally, in step 630, the processor 310 searches the local cache for an SMF profile having an N11 IP address matching the S5 IP address of the PGW-C 250a received from the MME 204. Accordingly, the method 600 illustrates establishment of the local cache 320 and the use of the local cache by the processor 310 to locate a matching SMF profile.

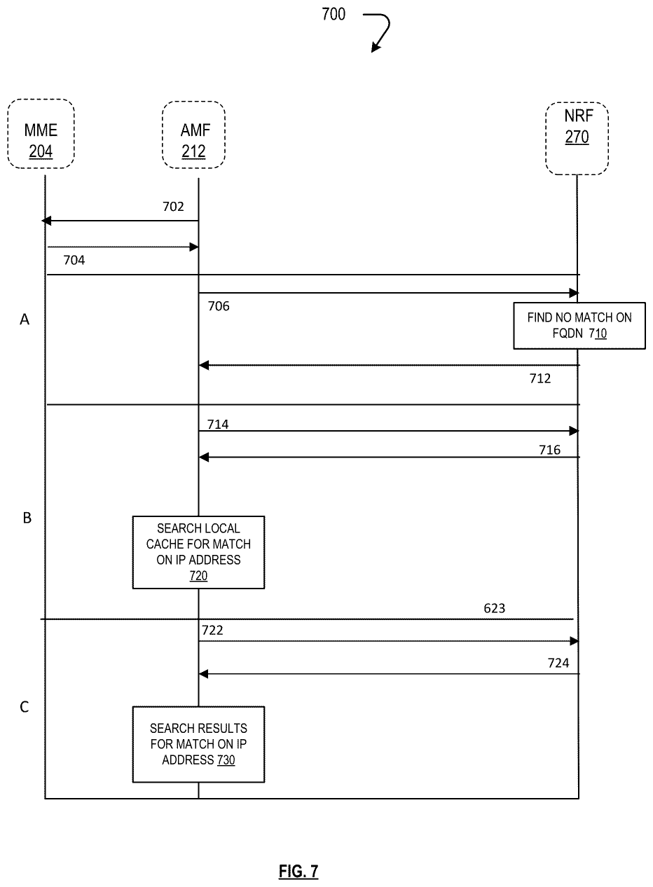

FIG. 7 illustrates three different methods for SMF selection. Any of the three methods may be utilized as an initial method and the others may be utilized as fallback methods for SMF selection. Although the interactions illustrated occur between the MME 204, AMF 212, and NRF 270, it should be understood that the SMF selection system 300 may communicate with the AMF 212 or the NRF 270 to trigger the operations described herein.

Upon receiving a session establishment request related to 4G LTE to 5G mobility, the AMF 212 sends a context request at step 702 to the MME 204 pertaining to the established 4G session. In step 704, the MME 204 responds with context information including the FQDN and the S5 IP address of the PGW-C 250a. Accordingly, to perform SMF selection methods A, B, and C, the AMF 212 is able to use this information transmitted from the MME 204 in order to select an SMF.

In scenario A, in step 706, the AMF 212 queries NRF 270 for an SMF profile having a matching FQDN to the FQDN of the PGW-C 250a received from the MME 204. In the illustrated scenario, in step 710, due to misconfiguration, no matching SMF is found. Accordingly, the NRF returns no instances to the AMF in step 712. Accordingly, scenario A activates the fallback trigger logic 312 described above with respect to FIG. 3.

In scenario B, the fallback trigger logic 312 activates the local cache matching logic 316. Thus, in step 714, the AMF 212 queries the NRF 279 to build the local cache of SMF profiles and in step 716, recently use SMF profiles are stored in the local cache. In step 720, the AMF 212 searches the local cache for an SMF profile having a matching N11 IP address to the S5 IP address of the PGW-C 250a.

In scenario C, the fallback trigger logic 312 activates the NRF query logic 318. In step 722, the AMF 212 queries the NRF 170 for all SMF profiles. The AMF 212 may query the NRF 270 for all SMF profiles using a network function (NF) Type=SMF query towards the NRF 170. The NRF 170 returns the SMF profiles in step 724. Finally, in step 730, the AMF 212 searches the results for an SMF profile having a matching N11 IP address to the S5 IP address of the PGW-C 250a. Scenarios A, B, and C may be combined in any appropriate manner to ensure SMF selection and session continuity.

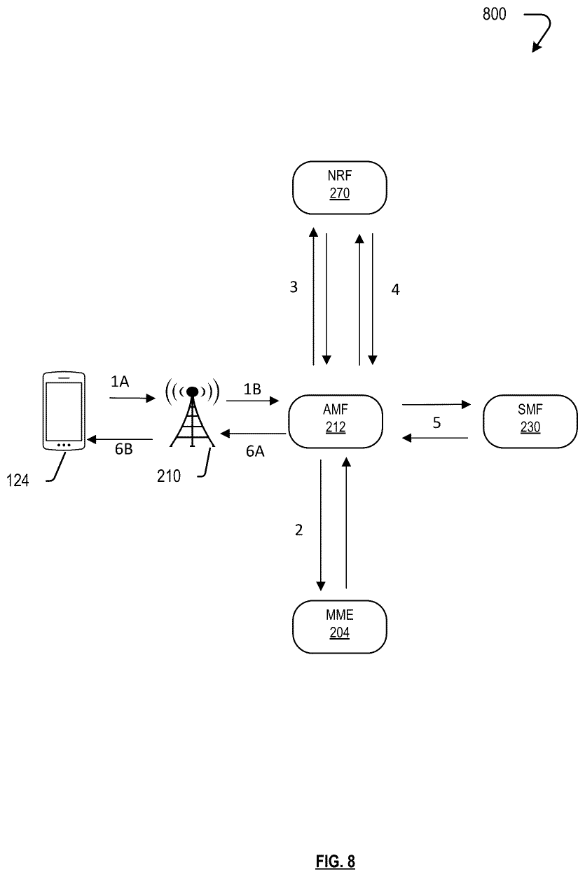

FIG. 8 illustrates SMF selection methods from session request to session establishment. As illustrated, wireless device 124 sends a PDU session establishment request towards a gNB 210 in step 1A and the gNB communicates with the AMF 212 in step 1B. In response, the AMF 212 sends a context request to the MME 204. The MME 204 returns information including an FQDN and an S5 IP address of the PGW-C 250a in step 2.

In steps 3 and 4, the AMF 212 communicates with the NRF 270 to perform any of the SMF selection methods A, B, and C described above with respect to FIG. 7 until one of the methods succeeds in completing SMF selection. Any of the three methods may be utilized as an initial method and the others may be utilized as fallback methods for SMF selection. However, in embodiments described herein, the fallback selection is triggered when the FQDN match fails. The FQDN match may fail when the SMF 230 is misconfigured, for example. Thus in steps 3 and 4, the AMF 212 builds and searches a local cache and performs a query on the NRF 270 for all SMF profiles when a match of the N11 IP address with the S5 IP address provided by the MME 204 is not found

When a match is found in step 4, the AMF 212 contacts the selected SMF by forwarding the PDU session establishment request in step 5 to continue the session. The SMF 230 interacts with the AMF 212 via the N11 interface to establish, coordinate and terminate different PDU sessions. The SMF 230 generates and sends a 201 created message from the selected SMF. Thus, in steps 6A and 6B, the registration of the wireless device 124 with the 5G core network is accepted. With the PDU session established, the UE can now transfer data with the 5G network. Throughout the session, the SMF 230 maintains the session context, which contains all the necessary information about the PDU session, such as the allocated resources, policy rules, and other session parameters.

Accordingly, as set forth above, embodiments provide for SMF selection during inter-RAT mobility. In some embodiments, methods 400, 500, 600, 700, and 800 may include additional steps or operations. Furthermore, the methods may include steps shown in each of the other methods. Additionally, the order of steps shown is merely exemplary and the steps may be re-ordered as appropriate. As one of ordinary skill in the art would understand, the methods 400, 500, 600, 700, and 800 may be integrated in any useful manner.

The steps of the methods described above can be combined or rearranged in any meaningful manner. Further, the exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

1. A method comprising:
querying a network repository function (NRF) from an access and mobility function (AMF) with a fully qualified domain name (FQDN) to locate a session management function (SMF) for managing a session during long term evolution (LTE) to fifth generation (5G) standalone (SA) mobility;
failing to locate the SMF for managing the session; and
upon failure to locate the SMF for managing the session based on the FQDN, matching a packet data network gateway (PGW) S5 internet protocol (IP) address with an N11 IP address of an SMF profile.

2. The method of claim 1, further comprising searching a local cache for the SMF profile.

3. The method of claim 2, further comprising utilizing the SMF profile from the local cache to identify the SMF for managing the session.

4. The method of claim 2, further comprising checking the local cache from the AMF.

5. The method of claim 2, further comprising failing to locate the SMF profile for the SMF for managing the session in the local cache and querying the NRF for all SMF profiles.

6. The method of claim 5, further comprising querying the NRF for all SMF profiles using a network function (NF) Type=SMF query towards the NRF.

7. The method of claim 6, further comprising finding an N11 IP address matching the PGW S5 IP address in one of the SMF profiles received from the NRF.

8. The method of claim 7, further comprising selecting the SMF having a matching IP address to manage the session.

9. The method of claim 8, further comprising creating a session from the AMF with the selected SMF.

10. A system comprising:
a memory storing data and instructions; and
a processor executing the stored instructions and performing operations including:
receiving a notification of failure to locate a matching session management function (SMF) for managing a session during long term evolution (LTE) to fifth generation (5G) standalone (SA) mobility for a wireless device; and
responsive to the notification, upon failure to locate the SMF for managing the session, checking a local cache to locate a profile for the SMF for managing the session by matching a packet data network gateway (PGW) internet protocol (IP) address with an N11 IP address of an SMF profile.

11. The system of claim 10, wherein the failure occurs responsive to querying a local cache from an access and mobility function (AMF) with a fully qualified domain name (FQDN).

12. The system of claim 11, further comprising utilizing the profile for the SMF from the local cache to identify the SMF for managing the session.

13. The system of claim 10, wherein the operations comprise checking the local cache from an AMF.

14. The system of claim 10, the operations further comprising querying a network repository function (NRF) for all SMF profiles.

15. The system of claim 14, wherein the operations comprise querying the NRF for all SMF profiles using a network function (NF) Type=SMF query towards the NRF.

16. The system of claim 15, the operations further comprising finding an N11 IP address matching the PGW S5 IP address in one of the SMF profiles.

17. The system of claim 16, the operations further comprising selecting the SMF having a matching IP address to manage the session.

18. A non-transitory computer readable medium storing instructions executed by a processor to perform operations comprising:
receiving a notification of failure to locate a matching session management function (SMF) for managing a session during long term evolution (LTE) to fifth generation (5G) standalone (SA) mobility for a wireless device; and
responsive to the notification, upon failure to locate the SMF for managing the session, locating a profile for the SMF for managing the session by matching a packet data network gateway (PGW) internet protocol (IP) address with an N11 IP address of an SMF profile.

19. The non-transitory computer readable medium of claim 18, the operations further comprising locating the profile in a local cache.

20. The non-transitory computer readable medium of claim 18, the operations further comprising querying a network repository function (NRF) for all SMF profiles to find the SMF profile.
